(19) United States
(12) Patent Application Publication
(10) Pub. No.: US 2007/0116523 A1
(43) Pub. Date: May 24, 2007

(54) SYSTEM AND METHOD FOR REMEDIATION OF WASTE MATERIAL AT CRUSHED STONE QUARRY SITES

(76) Inventors: Fred L. Beebe, Atlanta, GA (US); Doug Lambert, Maryville, TN (US); Woody Sanderson, Macon, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/556,150

(22) Filed: Nov. 2, 2006

Related U.S. Application Data
(60) Provisional application No. 60/596,979, filed on Nov. 2, 2005.

(51) Int. Cl. B09C 1/00

(52) U.S. Cl. 405/128.1

(57) ABSTRACT

A three-stage grizzly which separates rock having a diameter greater than approximately twelve (12) inches from the overburden, additional in-line screening equipment designed to separate rock having a diameter greater than 4″, mass blending and refined blending equipment, and conversion stations which allow further size reduction with crushing equipment as specified by customers. The grizzly and the screening equipment combine to precisely separate the overburden from the rock having a diameter in the range of approximately four (4) to twelve (12) inches, all of which is returned to the quarry as revenue material. The remainder of the overburden is mixed with waste fines at various stages in the process, and processed through classification and size reduction stations to produce a beneficial use material that has multiple uses in the market place.

### CROSS REFERENCE TO RELATED APPLICATIONS

This application incorporates by reference and claims the benefit of the filing date of United States Provisional Application for patent filed on Nov. 2, 2005 and assigned Ser. No. 60/596,979.

### BACKGROUND OF THE INVENTION

1. Field of the Invention

This invention relates to solid waste remediation systems and, more particularly, to the systems and methods required to deal with overburden waste and waste fines at crushed stone quarry sites and other mining applications. The purpose and benefit is to remove wastes from mining operations property, heretofore not practical, and in doing so, create a beneficial use product in demand in various consumer applications. The invention is inimitable within the crushed stone and other mining businesses, and is welcomed in principal by those owners and operators.

2. Background of the Invention

During normal operations of crushed stone quarries, overburden material must be stripped from virgin land in order that underlying stone reserves can be blasted, extracted, and processed for sale. The extent of stripping varies from site to site depending upon the depth of overburden, the direction the mining plan is taking the quarry, and the nature of the topsoil and organics. But in all cases, overburden has heretofore been a waste material and a cost encumbrance on a quarry's operating efficiency.

In addition to overburden waste, the stone crushing and washing process at these quarries produces a residual material called waste fines, microscopic in size. Both waste fines and overburden are always transported and stockpiled to areas generally adjacent to, or within, the core activity center of the quarry. These stockpile areas are tolerated until they grow to a size that impedes quarry operations. Typically, the response to this problem is to allocate a new area within the quarry for the stockpile, and then to transport the stockpiled material to that area. Thus, overburden material, waste fines, and the rock trapped within the overburden, is transported and stockpiled multiple times due to the restricted land area within many quarries and the zoning restrictions to depositing the waste outside the quarry property. This movement of large quantities of waste is a constraint to a highly cost-efficient quarry operation, and a direct offset to profit. Furthermore, stored waste has a harmful impact on the quarry, including a heightened level of airborne particulate matter, and objectionable stormwater runoff patterns.

A process is needed to deal with stripped overburden and waste fines in a way that greatly minimizes quarry waste handling, storage costs, and environmental harm. The invention accomplishes these things, and within the patent process, a beneficial use material, eagerly sought by the consumer is created.

### BRIEF SUMMARY OF THE INVENTION

The above limitations of previously known systems and methods for dealing with overburden and waste fines are overcome by a system and method that operate in accordance with the principles of the present invention. The inventive system converts overburden, waste fines, and other production-generated waste from mining operations and quarries into a beneficial use product.

Generally, the present invention technology uses primary classification of overburden, further selective size classification, and the introduction of waste fines from the quarry crushing process to create a marketable beneficial use material for construction sites as engineered fill material. Other industrial waste materials may be blended with the quarry waste, including, but not limited to, vegetative waste, animal waste, and power generation fly ash waste. This would be done for specialized consumer applications. The result of the invention is to alleviate domiciled waste in the respective industries, and convert, thru blending technology, a beneficial use material for the American public.

Another major role of the invention is the return of marketable rock trapped within the stripped overburden to the quarry revenue stream, thus creating a lower cost crushed stone material to the quarry. The opening of greenfield quarries can be forestalled by mining the reserves buried beneath overburden waste stockpiles, often containing several million cubic feet.

The system of the present invention includes a vibrating grizzly for separating the rock that is greater than approximately twelve (12) inches from the remaining overburden. The rock in the approximately 4″ to 12″ range is recovered down-line in the classification process and returned to normal quarry operations. Thus, all 4″ and larger rock, recovered from stripped overburden, is returned to the normal quarry production system. Stored waste fines from crushing operations is introduced into the remediation stream at various points, in formulaic proportions, and the result is a beneficial use product with high value in many consumer applications. A series of conveyors tie the aforementioned processed waste to a stockpile(s) for shipment from the quarry to outside market uses. The components of the system thereby recover 4″>rock so that it may be returned to quarry operations and processed in normal operations. Finally, the overburden residue, the waste fines, and the minus 4″ rock are mixed to produce a blended beneficial use material. Other market requirements would dictate additional classification and size reduction stages, as well as the possible introduction of other industrial wastes including, but not limited to, animal wastes, vegetative wastes, and power generation fly ash wastes. The formulaic blended material, designed for specific beneficial uses in the consumer market, is then deposited into a conical pile. Further refined blending also occurs as the material is removed from the conical pile and loaded into trucks for delivery to customer locations.

The specific methods of the present invention includes vibrating the quarry overburden material through a grizzly classifier to separate rock greater than approximately twelve (12) inches in diameter from the overburden, screening the output of the grizzly to separate the rock having a diameter of approximately four (4) to twelve (12) inches from the remaining overburden, and adding waste fines, generally 20% to 45% by volume, to the remaining overburden residue to produce a marketable material responsive to consumer requirements. The method then recovers rock typically in the 4″ to 12″ range for return to the quarry operations. The waste fines from crushing are added to the overburden residue at appropriate volumetric levels to produce a blended material that may be used in a variety of market applications. Further blending occurs in the depositing of the material into a conical pile, and additional blending may also occur as the material in removed from the conical pile for shipment.

Nature of the Business

Quarry Remediation International, LLC provides a solution for permanently removing the overburden and pond sand waste generated from mining and stone production from many aggregate (stone) quarries where stockpiling the waste would inhibit quarry growth, or adds unreasonable handling costs, or both. The means of doing so, proprietary to QRI, is a process of vigilantly blending these waste materials, returning the rock contained in the overburden, generally 20%-30% by volume, to the quarry as a profit source, and selling the resulting product as an engineered fill material to real estate development and construction applications for unsuitable sites where imported fill material is required.

The fill material produced by QRI from quarry waste will have engineering properties consistent with rigorous geotechnical standards for placement and compaction and will be marketed as a cost-efficient and environmental safe solution heretofore unavailable.

The product advantages will be distributed to area geo-technical engineers, grading contractors and land development firms. Additionally, QRI products will be desirable for use under roadbeds, in deep fills, for pond lining use, and in other applications where it is important to have soil consistency and excellent load bearing characteristics.

This entire waste removal process allows the quarry operators to reclaim land that is currently occupied by stockpiles of these waste materials, allowing the quarry property to be mined to the fullest extent of its original mining plan. The positive operating margin opportunities afforded by QRI to the aggregate companies is substantial and clearly warranted.

Market Opportunity

The initial target market for Quarry Remediation International, LLC consists of the rock quarries located in the southeast United States. The top five aggregate producers have approximately 100 quarries in the five southern states, and almost 1000 quarries exist in North America. We have planned for methodical, organized growth in the first five years, with a capacity to remediate a minimum of four quarries per year, and more depending on financing strength to do so. The average annual QRI production per quarry will be 600,000 cubic yards of processed material, and the duration in each quarry would be six months.

Nature of the Business

Quarry Remediation International, LLC provides a solution for permanently removing the overburden and pond sand waste generated from mining and stone production from many aggregate (stone) quarries where stockpiling the waste would inhibit quarry growth, or adds unreasonable handling costs, or both. The means of doing so, proprietary to QRI, is a process of vigilantly blending these waste materials, returning the rock contained in the overburden, generally 20%-30% by volume, to the quarry as a profit source, and selling the resulting product as an engineered fill material to real estate development and construction applications for unsuitable sites where imported fill material is required.

The fill material produced by QRI from quarry waste will have engineering properties consistent with rigorous geotechnical standards for placement and compaction and will be marketed as a cost-efficient and environmental safe solution heretofore unavailable.

The product advantages will be distributed to area geo-technical engineers, grading contractors and land development firms. Additionally, QRI products will be desirable for use under roadbeds, in deep fills, for pond lining use, and in other applications where it is important to have soil consistency and excellent load bearing characteristics.

This entire waste removal process allows the quarry operators to reclaim land that is currently occupied by stockpiles of these waste materials, allowing the quarry property to be mined to the fullest extent of its original mining plan. The positive operating margin opportunities afforded by QRI to the aggregate companies is substantial and clearly warranted.

Market Opportunity

The initial target market for Quarry Remediation International, LLC consists of the rock quarries located in the southeast United States. The top five aggregate producers have approximately 100 quarries in the five southern states, and almost 1000 quarries exist in North America. We have planned for methodical, organized growth in the first five years, with a capacity to remediate a minimum of four quarries per year, and more depending on financing strength to do so. The average annual QRI production per quarry will be 600,000 cubic yards of processed material, and the duration in each quarry would be six months.

Thus, the system and method of the present invention separate marketable rock from the overburden material so that it may be sold as part of the quarry's ongoing operations. The remaining residue, thru the process of classification, size reduction, and screening, is blended with the waste fines, and other industrial wastes, to produce a specialized material that is then sold for use in many market applications. The ratio of screened overburden to waste fines is a formula dependent upon general soil characteristics and the market application.

### BRIEF DESCRIPTION OF THE SEVERAL VIEWS OF THE DRAWING

FIG. 1 Attached to this application is a flow diagram of the process implemented by the system of the present invention for the remediation of in situ overburden and waste fine stockpiles.

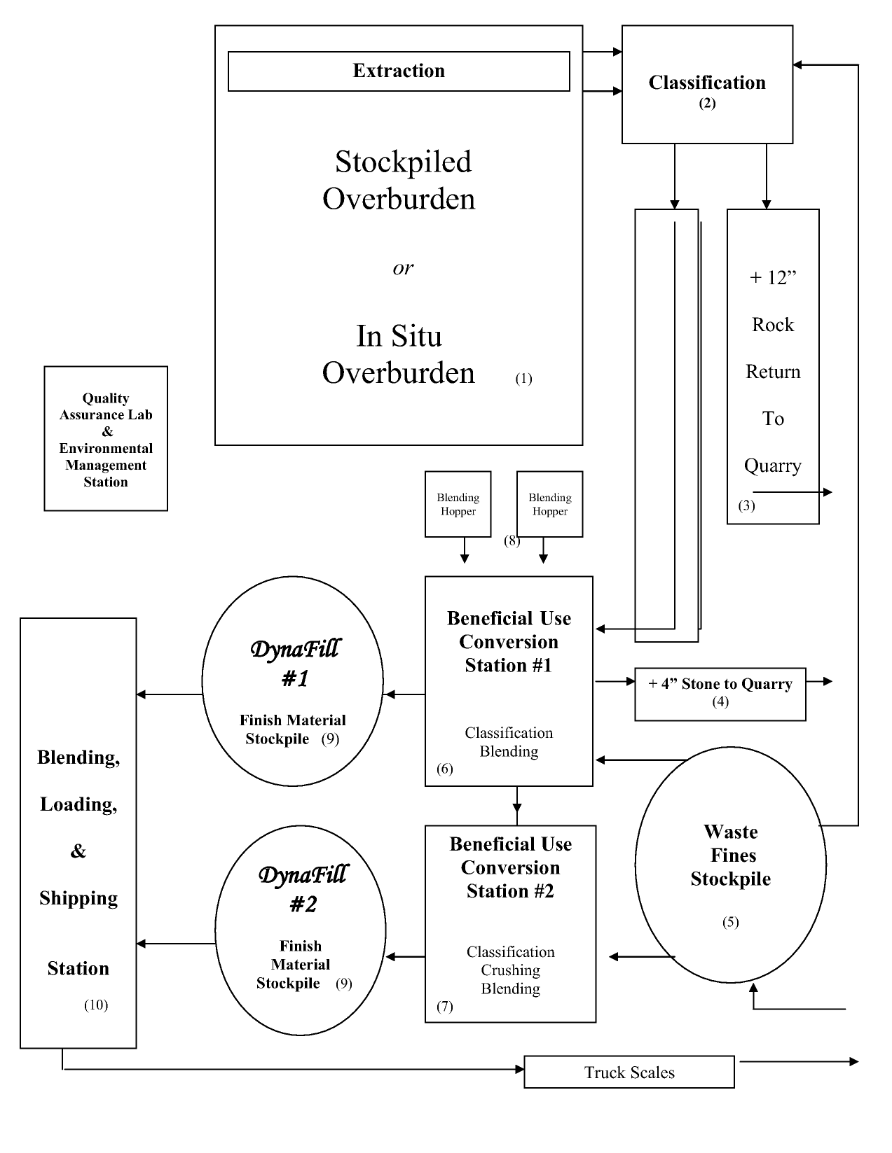

### DETAILED DESCRIPTION OF THE INVENTION

An exemplary system made in accordance with the principles of the present invention includes a vibrating grizzly, transfer conveyor systems; further fine screening devices, blending hoppers for introducing specialized ingredients, beneficial use conversion stations, and stockpiles to accommodate each material. The remediation process begins by moving stockpiled overburden or in-situ overburden (1) to the vibrating grizzly (2). The overburden is then vibrated to separate the rock that is greater than approximately (12″) twelve inches in diameter from the rest of the overburden. That rock is returned to the quarry (3) for inclusion in typical processing and shipping operations. The remaining overburden is transferred to the beneficial use conversion center (6) and the specialized material conversion station(s) (7). Conversion station number one combines a screening system with specialized blending, adjusted to the market application. The second material conversion center is identical to conversion station number one, except that it includes crushing equipment not present in conversion station number one, again adjusted to market requirements. Consequently, all market requests for special blending and size reduction are accomplished within stations one and two. Both stations utilize blending equipment and conveyors when the introduction of other industrial wastes is required. The screening process separates the rock having a diameter in the range of approximately four (4) inches to twelve (12) inches from the remaining overburden. These separated 4″+rocks (4) are returned to the quarry for inclusion in typical processing and shipping operations.

A system and method for capturing and treating overburden waste and waste fines at an aggregate quarry or other mining applications such that a marketable beneficial use material is produced for multiple consumer applications. These market applications could be, but are not limited to, engineered fill for construction sites, and blended compost for growing medium applications. Thus, the invention allows a quarry operator to rid the quarry of multiple handling and stockpiling of waste materials within the confines of the quarry, which heretofore has inhibited a cost-efficient operation. The patent method includes a formulaic means of blending these wastes to produce a beneficial use material acceptable to the real estate industry as engineered fill material for construction sites. On occasion, depending on the geographical location of the quarries, waste from other industries can also be blended with the blended quarry wastes, including, but not limited to, animal waste, vegetative waste, and power generation fly ash waste. Furthermore, raw storage of overburden and crushed stone fines in quarries has a harmful impact on the quarry, including lowered air quality, and troublesome stormwater runoff. This negative quality of life impact is unacceptable to responsible quarry operators and to regulatory agencies.

As described, the patented system includes a three-stage grizzly which separates rock having a diameter greater than approximately twelve (12) inches from the overburden, additional in-line screening equipment designed to separate rock having a diameter greater than 4″, mass blending and refined blending equipment, and conversion stations which allow further size reduction with crushing equipment as specified by customers. The grizzly and the screening equipment combine to precisely separate the overburden from the rock having a diameter in the range of approximately four (4) to twelve (12) inches, all of which is returned to the quarry as revenue material. The remainder of the overburden is mixed with waste fines at various stages in the process, and processed through classification and size reduction stations to produce a beneficial use material that has multiple uses in the market place.

The remainder of the overburden continues through the remediation process. The waste fines, defined as particulate matter generated in the crushing process, (5) is added at various points in the system at a ratio, generally 15% to 45% by volume, that results in a beneficial use material. Depending upon the end use in the market and the customer specification, waste fines can be added to overburden as it's transported by conveyors to the conversion centers, or it may be added within one of the final conversion centers themselves. Regardless, the waste overburden and waste fine materials are transported by conveyor to beneficial use conversion station #1 for further blending to accommodate consumer requirements, (6), or to beneficial use conversion station #2 (7) for further classification and size reduction in accordance with more specialized and refined consumer requirements. Additives may be stored and added as required at blending stations (8). The various blended materials are transferred to formula stockpiles (9) where it is readily available for shipment. From there, the graded materials are loaded into trucks and weighed at the scales (10) for sales purposes.

While the present invention has been illustrated by the description of exemplary processes and system components, and while the various processes and components have been described in considerable detail, applicant does not intend to restrict or in any way limit the scope of the appended claims to such detail. Additional advantages and modifications will also readily appear to those skilled in the art. Therefore, the invention in the broadest aspects is not limited to the specific details, implementations, or illustrative examples shown and described. Accordingly, departures may be made from such details without departing from the spirit or scope of applicants' general inventive concept.

What is claimed is:

1. A system for the remediation and subsequent removal of overburden and waste fines at a crushed stone quarry or other mining operations, comprising:
a vibrating grizzly for separating the rock that is greater than approximately twelve (12) inches in diameter from the overburden,
screening equipment for separating the rock having a diameter of approximately four (4) to twelve (12) inches from the remaining overburden, and
a loading mechanism for introduction of waste fines into the remediation processing system, and
loading hoppers for the introduction of special additives and other industrial wastes, and
a specialized conversion station for additional screening and blending to produce an engineered fill product, and
an in-line conversion station including refined crushing and blending to meet more rigid market requirements.

2. The system of claim 1 further including:
a conveyor for moving the various materials from conversion centers to a storage pile.

3. A method for the remediation of overburden and waste fines at an aggregate quarry, comprising:
vibrating overburden material with a grizzly to separate the rock that is greater than approximately twelve (12) inches in diameter from the overburden,
screening the output of the grizzly with screening equipment to separate the rock having a diameter of approximately four (4) to twelve (12) inches from the remaining overburden, and adding waste fines to the overburden residue to produce a marketable beneficial use material.
further screening, size reduction, and adding waste fines to the overburden residue.

4. The method of claim 3 further including:
moving the material from the conveyors to the beneficial use conversion stations, and
subsequently conveying the classified and blended materials to the finish material stockpiles.
